(19) United States
(12) Patent Application Publication
(10) Pub. No.: US 2025/0348704 A1
(43) Pub. Date: Nov. 13, 2025

(54) SYSTEMS AND METHODS FOR CONTROLLABLE ARTIFICIAL INTELLIGENCE AGENTS

(71) Applicant: Salesforce, Inc., San Francisco, CA (US)

(72) Inventors: Zhiwei Liu, Santa Clara, CA (US); Weiran Yao, Mountain View, CA (US); Silvio Savarese, Palo Alto, CA (US); Shelby Heinecke, San Francisco, CA (US); Jianguo Zhang, San Jose, CA (US); Huan Wang, Palo Alto, CA (US); Caiming Xiong, Menlo Park, CA (US)

(21) Appl. No.: 18/817,064

(22) Filed: Aug. 27, 2024

Related U.S. Application Data
(60) Provisional application No. 63/645,606, filed on May 10, 2024.

(51) Int. Cl. G06N 3/042

(52) U.S. Cl. CPC G06N 3/042

(57) ABSTRACT

Embodiments described herein provide an optimization framework to control LLM agent behavior using dynamically optimized principles as part of the generation context. Specifically, a principle may take a form of a set of logic, parameters or text that describe the conditions for using that action. An LLM agent may generate a next step action conditioned on a set of principles corresponding to a set of available actions, and an execution trajectory. A reflector model (such as an LLM) may then generate a reward score based on the generated trajectory and the set of principles. Based on the reward scores, an optimizer (such as an LLM) may revise the set of principles to better align with observed conditions.

### CROSS-REFERENCE(s)

The instant application is a nonprovisional of and claims priority under 35 U.S.C. 119 to co-pending and commonly assigned U.S. provisional application No. 63/645,606, filed May 10, 2024.

This instant application is related to co-pending and commonly assigned U.S. nonprovisional application Ser. No. ______(attorney docket no. 70689.346US01), filed on the same day.

The aforementioned application(s) are hereby expressly incorporated by reference herein in their entirety.

### TECHNICAL FIELD

The embodiments relate generally to machine learning systems for machine learning systems and natural language processing (NLP), and more specifically to systems and methods for controllable artificial intelligence (AI) agents.

### BACKGROUND

AI conversation agents, commonly known as chatbots or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI conversation agents can assist with product recommendations, order tracking, and personalized shopping experiences. In information technology (IT) support, these agents can guide users through troubleshooting steps, helping them resolve software and hardware issues. Specifically, for network hazards, AI conversation agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task. However, in this generative process, various factors, such as inaccurate output text that does not align with real world information or experiences, known as “hallucination,” agent execution failing to follow a desired pattern, and/or the like, may lead to failure to an action flow that may not complete the desired task. For example, when an AI gent relies on its programmed diagnostic steps to interact with a user to identify a root cause of network issue, but lacking real-time external information (e.g., the internet service provider's status) and guidance or controllability of agent behavior, may end up misidentifying the issue.

### BRIEF DESCRIPTION OF THE DRAWINGS

FIG. 1 is a simplified diagram illustrating an AI agent generating a response and/or executing an action in response to a user query, according to some embodiments.

FIGS. 2A-2B provide alternative examples of AI agent generated next step action using reasoning abilities of neural network language models, according to some embodiments.

FIG. 3 provides a simplified diagram illustrating an LLM based framework generating a next step action and dynamically update a set of principles for guiding action execution, according to some embodiments.

FIG. 4 provides a simplified diagram illustrating an LLM based framework generating a next step action and dynamically update a state graph for guiding action execution, according to some embodiments.

FIG. 5 provides an example diagram illustrating an inference of a controllable agent generation using stage graph in FIG. 4, according to one or more embodiments described herein.

FIG. 6 provides an example diagram illustrating reflective adaption of the stage graph in FIG. 4 based on the task executions, according to one or more embodiments.

FIG. 7 is a simplified diagram illustrating a computing device implementing the LLM agent framework described in FIG. 1, according to one embodiment described herein.

FIG. 8 is a simplified diagram illustrating the neural network structure implementing the LLM agent module described in FIG. 7, according to some embodiments.

FIG. 9 is a simplified block diagram of a networked system suitable for implementing the LLM agent framework described in FIGS. 1-8 and other embodiments described herein.

FIG. 10 is an example logic flow diagram illustrating an example method of controlling a neural network based artificial intelligence (AI) agent, according to embodiments described herein.

FIG. 11 is an example logic flow diagram illustrating an example method of controlling a neural network based artificial intelligence (AI) agent, according to embodiments described herein.

FIGS. 12-13 show example performance charts comparing methods described in FIGS. 10-11 against the agent baselines, according to embodiments described herein

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

### Overview

An LLM agent may generate a next step action to perform a complex task, such as to design a trip itinerary, and/or the like. This process can often be handled as a multi-turn action execution, during which the LLM generates an output action at each turn of inference by observing the execution output from the last turn. In this case, an LLM agent has both memory for past actions and observations, and an action space to navigate for a next step action. These information can be added into a prompt to guide the LLM to generate an output at each turn during inference.

To avoid hallucination and improve accuracy action executions of the LLM agent, existing LLM agents may be customized with specific designs of the action spaces, such as function calls and code execution. For example, along with a well-designed agent reasoning framework, e.g., tuning the prompts for the agent, an LLM agent is able to consecutively generate correct actions. Though tuning the prompts of LLM agent for optimal reasoning ability helps to improve output accuracy, the agent execution may fail to follow a deterministic pattern even if the prompt provides detailed instruction. This is due to the hallucination of LLM, which deteriorates when an agent runs more steps and the context increases. Additionally, the size of action space compounds the challenge to execute a correct action, because all the available actions is required to be organized into the prompt with current agent building frameworks.

In view of the need for controllable LLM generation, embodiments described herein provide a unified framework to control LLM agent behavior using a state graph as a context for LLM agent execution. The agent's behavior is articulated through the state graph where each node represents a distinct state correlating with predefined agent executions, viewed as deterministic actions. Edges between these nodes define transitions, representing decision-making processes that lead from one state to another. This state graph ensures that each state is strategically connected to subsequent potential states, thereby systematizing the agent's execution workflows through controlled state transitions. Such graph may be dynamically modified by an LLM to add or remove nodes or edges representing unseen tasks. In this way, at each action turn, the LLM agent may generate a next step action based on a current state graph and prior action trajectory.

In one embodiment, the transition mechanism between states may be constructed by different implementations, such as heuristic/rules-based transition, classifier-based transition, and direct LLM reasoning transition, and/or the like. For example, for heuristic-based transitions, a set of pre-defined conditional rules such as context matching are employed to facilitate state progression. For another example, classifier-based transitions utilize classification algorithms to predict the most probable subsequent state from a given current state. For another example, LLM-based transitions leverage the intrinsic reasoning capabilities of the LLM to determine the next appropriate states, enriching the decision-making process with advanced cognitive modeling. After the next states are determined, the LLM agent may in turn determine and execute the next step action to transit to the next states.

In one embodiment, the state graph may be developed through different implementations. For example, the graph may be meticulously designed and pre-stored by human experts to ensure precise control and alignment with desired agent behaviors. For another example, a data-driven method utilizes extensive datasets of agent executions to train and optimize the state graph, allowing it to adapt based on empirical data. For another example, an LLM may be utilized to construct and/or to edit the graph, such as the addition or removal of nodes and edges. In this way, the state graph may be adapted and/or dynamically evolved based on the operational feedback.

Therefore, by constructing and integrating the stage graph in LLM agent action execution, the predictability and reliability of LLM agent executions can be improved. As the stage graph is scalable by adding more nodes and/or edges, the framework can be adapted to handle complex task requirements, which significantly reduces human efforts in iterative adjustments of the optimal workflow in traditional prompt and/or action space designing. In this way, neural network technology in operating LLM agents is largely improved.

Further embodiments described herein provide an optimization framework to control LLM agent behavior using dynamically optimized principles as part of the generation context. Specifically, a principle may take a form of a set of logic, parameters or text that describe the conditions for using that action. An LLM agent may generate a next step action conditioned on a set of principles corresponding to a set of available actions, and an execution trajectory. A reflector model (such as an LLM) may then generate a reward score based on the generated trajectory and the set of principles. Based on the reward scores, an optimizer (such as an LLM) may revise the set of principles to better align with observed conditions.

In one embodiment, each action in a pre-defined action space is associated with a principle that describe the conditions for using that action. During execution, an AI agent can check these principles before generating the next action. Compared to simple action descriptions, principles provide more detailed conditions on when to use the action and offer specific instructions on how to generate the parameters for an action.

In one embodiment, an optimization framework operates in three stages: execution, reflection, and optimization. During the execution stage, an AI agent may perform tasks using predefined or null principles and memorizes the task trajectories. In the reflection stage, the AI agent may review its task executions, evaluating how actions were selected and whether they met the task requirements, and generate a reward score. Finally, in the optimization stage, an optimizer network refines principles to enhance agent performance. For example, the optimization network may individually optimize principles for each trajectory. Or alternatively, all reward scores of trajectories in a batch are concatenated and fed to the optimization network to update the set of principles.

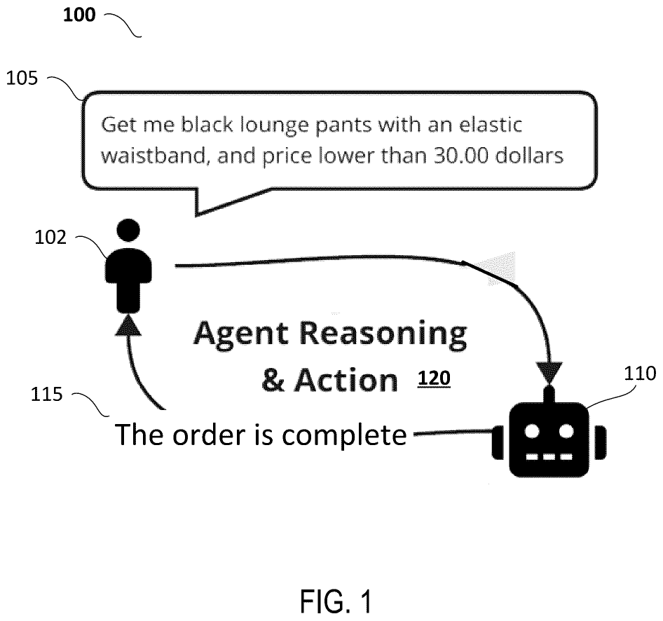

FIG. 1 is a simplified diagram illustrating an AI agent generating a response and/or executing an action in response to a user query, according to some embodiments. For example, a human user 102 may provide a task query 105 of “get me black lounge pants with an elastic waistband, and price lower than 30.00 dollars,” e.g., via a user interface of a conversation session of an e-Commerce website or a shopping mobile app. Such task request 105 may be transmitted to an AI agent deployed at a server, or an AI agent implemented on a user device. The AI agent 110 may in turn use language reasoning capabilities that an underlying LLM has been pretrained with to determine a next step action at 120. For example, usually one or more actions may be carried out, such as a first action of “search on black lounge pants,” “generate an order page,” “process payment,” and/or the like.

At each time step, the execution of a prior action may be returned to the input side as a context for next-step generation. For example, after AI agent 110 returns a list of available “black lounge pants with an elastic waistband” after executing an action of “search,” user 102 may further enter additional input such as a selection of one of the listed search results, additional input to revise the search, and/or the like. Such additional input from user 102 may be fed to AI agent 110 for generating the next step action, e.g., whether to proceed to a purchase page, or to revise the search.

For example, the AI agent 110 may consecutively execute actions [a₁, a₂, . . . , aₙ] and collects observations [o₁, o₂, . . . , oₙ] from environments, where oᵢ is the execution results of aᵢ. The environment can be an e-Commerce webpage, an IT configuration page, and/or the like.

The AI agent 110 may employ a policy function π(aₜ|cₜ) to predict the next action at given the execution trajectory context cₜ=[(a₁, o₁), (a₂, o₂), . . . , (aₜ₋₁, cₜ₋₁)]. The AI agent 110 may utilize a language model to determine the policy function, which requires textual trajectory information for the prompt as follows:

$$π ( {a}_{t} \vert {c}_{t} ) = Executor ( {a}_{t} \vert 𝒯 ( {c}_{t} ) ) , \qquad ( 1 )$$

where [symbol] is the prompt template to organize context information. Intrinsically, those context information is text-based, including action names, action parameters and observations.

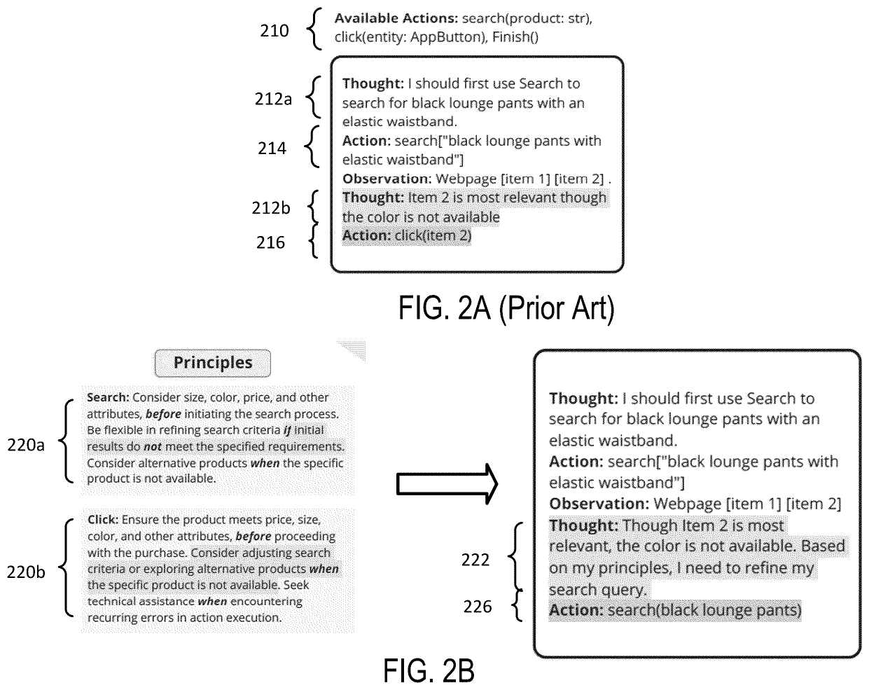

FIGS. 2A-2B provide alternative examples of AI agent generated next step action using reasoning abilities of neural network language models, according to some embodiments. As shown in FIG. 2A, in some embodiments, agent execution may fail to make decisions when faced with contradictory observations, particularly during the execution of long-step tasks. For example, an action space 210 comprising a search action, a click action and a finish action may be pre-defined for an AI agent to interact with a shopping website. In response to a received task query 105 in FIG. 1, the AI agent first determine a first action is search 214, e.g., through reasoning capability 212a. The AI agent may further obtain an observation of executing the search action 214, e.g., a webpage of [item 1] and [item 2]. By observing that item 2 does not having the available color, the AI agent may input the observation 212b and generate a next action 216, e.g., still clicking [item 2] as it appears most relevant. Thus, AI agent may fail to make the right decision after the first search action and the observations of the execution results of the first search action.

Instead, as shown in FIG. 2B, instead of generating a next step action without guidance, the AI agent may employ a set of principles 220 as context. For example, the set of principles 220 may be a set of instructions 220a-220b that correspond to each action in the action space 210. For each action, a principle may prescribe, e.g., in natural language, rules and/or guidance on how to make a decision on whether to execute the respective action. In other implementations, a principle may take a form of tunable embeddings, parameters, and/or the like.

In one embodiment, the AI agent may combine the set of principles 220 with the task input 105 to generate a next step action. As a result, after executing a first search action (similar to that described in FIG. 2A), the AI agent may follow the principle 220a to reason that [item 2] is not available and therefore another search action is to be carried out to refine the search (at 222). Therefore, the AI agent may make a decision to generate a next step “search” action 226 to refine the search with an improved query, enhancing its decision-making process.

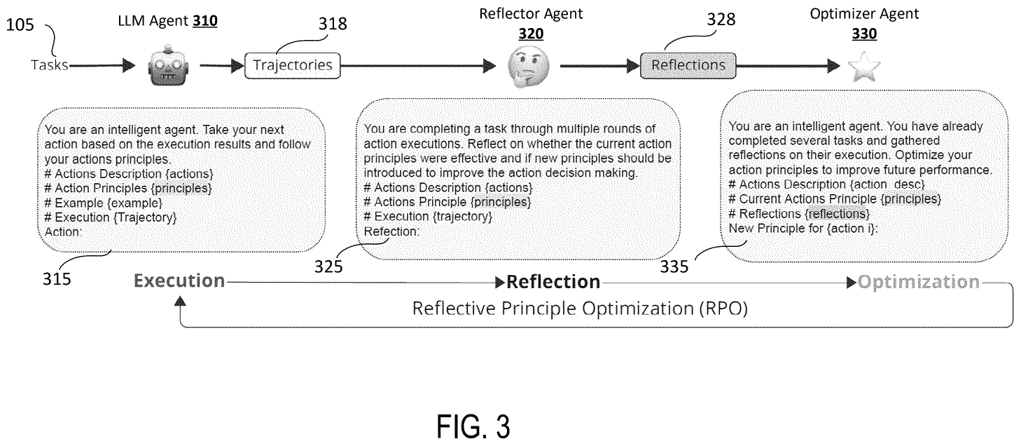

FIG. 3 provides a simplified diagram illustrating an LLM based framework generating a next step action and dynamically update a set of principles for guiding action execution, according to some embodiments. In one embodiment, in response to a task request 105, the AI agent may iteratively generate a next step action and in turn dynamically optimize such generation via an optimization network. For example, the optimization framework may be implemented by a generative AI agent 310, a reflector agent 320 and an optimizer agent 330. In one embodiment, the agents 310-330 may be the same or different LLMs, using different prompts to generate different outputs in response to an input request. Specifically, each iteration may comprise three stages: execution, reflection and optimization. During execution, an AI agent 310 executes tasks with previous principles to form trajectories 318. Then, the reflector agent 320 reflects on those tasks executions. Finally, the optimizer agent 330 leverages those self-reflection results to optimize the principles.

In one embodiment, at execution, given a set of tasks, the executor AI agent 310 performs actions based on the current set of principles, collecting observations from the environment. The AI agent 310 may constrain the reasoning of LLM to follow a set of principles P as follows:

$$π ( {a}_{t} \vert {c}_{t} ) = Executor ( {a}_{t} \vert 𝒯 ( {c}_{t} ) ; P ) . \qquad ( 2 )$$

For example, the principles P are constraints or guidelines that help shape the decision-making process of LLM agent. Principles provide instructions on the usage of the action such as how to generate parameters for the action. Additionally, principles reduce the set of potential actions by eliminating those that do not conform to the defined guidelines, thereby narrowing the search within the action space. Here, the principles space to be the same as actions space, i.e. each aᵢ∈A associated with a pᵢ∈P.

In one embodiment, the principles P may take a form of a natural language text, or an embedding, parameters, and/or the like.

The execution stage involves prompting the LLM agent to generate actions, which regressively calls Eq. (2) until reaching the final actions or maximum steps. Given a task query q (e.g., 105), the resulting trajectory 318 may be denoted as c_{q}=[(a_{q}⁽¹⁾, o_{q}⁽¹⁾, a_{q}⁽²⁾, o_{q}⁽²⁾ q), (a_{q}⁽ⁿ⁾, o_{q}⁽ⁿ⁾]. Note that those actions may be some inner actions, which do not forward to the environment and are associated with a default or null observation. Executor collects a set of trajectory context sequences C for those queries during execution stage Q.

For example, the example prompt template 315 may include the action principes and prior execution trajectories, and/or an example of action as an input to AI agent 310. When AI agent 310 is an IT support agent to identify network connection issue for a user, AI agent 310 may execute actions such as a search action (to search within a database of network issue identifications), a test action (to execute test command on one or more network devices such as gateway or router to test connectivity), and/or the like, on an environment on a network infrastructure such as a local area network (LAN). Observations, such as a response to the testing action, a search result from the database in response to the search action, may be obtained by the AI agent 310.

After executing the actions, a reflector agent 320 reflects on trajectories C 318 by analyzing the collected observations. This reflection stage involves evaluating the effectiveness of the actions in each trajectory and the adherence to the principles to generate a reflection or reward score 328:

$${r}_{q} = REFLECTOR ( {c}_{q} , P ) , \qquad ( 3 )$$

for all c_{q}∈C. The reflection process identifies conditions or guidelines where the principles need adjustment to better handle the observed tasks. If an environment provides rewards toward the execution, it is a reward-based reflector aligning the executions with reward feedback. Instead, if no rewards present for execution, it is a self-reflector.

For example, the example prompt template 325 may include the action principes and prior execution trajectories, and/or an example of action as an input to AI agent 320 to generate a reflection or reward score.

Based on the reflection results, the optimization AI agent 330 utilizes the generation ability of LLM to refine the principles for improving the performance of agent in similar future scenarios. The optimization stage involves refining the principles to better align with the observed conditions and enhance decision-making.

In one implementation, the optimization AI agent 330 may individually consider each trajectory and its reflection 328 to optimize principles. Then a batch of principles are summarized as a new set of tailored principles P*:

$${P}^{*} = {\sum }_{Q}^{} OPT ( rq , P ) , \qquad ( 4 )$$

where ΣQ denotes a summarize or of all principles generated from optimizer OPT 330 for all queries “Q”.

In one implementation, the optimization AI agent 330 may use a prompt template to concatenate all the reflections in a batch. Then the optimizer directly generates new principles via considering all those reflections, which is formulated as follows:

$${P}^{*} = OPT ( CONCAT \{ rq \vert q ∈ Q \} , P ) , \qquad ( 5 )$$

where CONCAT denotes using a prompt template to concatenate those reflections. Thus, by concatenating a batch of trajectories, the optimizer AI agent 330 only needs one time principles generation but with |Q| times longer context length. In comparison, by individually optimize the principles per trajectory, the optimizer AI agent 330 requires generating principles for |Q|+1 times. Hence, long context reasoning ability is necessary for an optimizer in the batch optimization method.

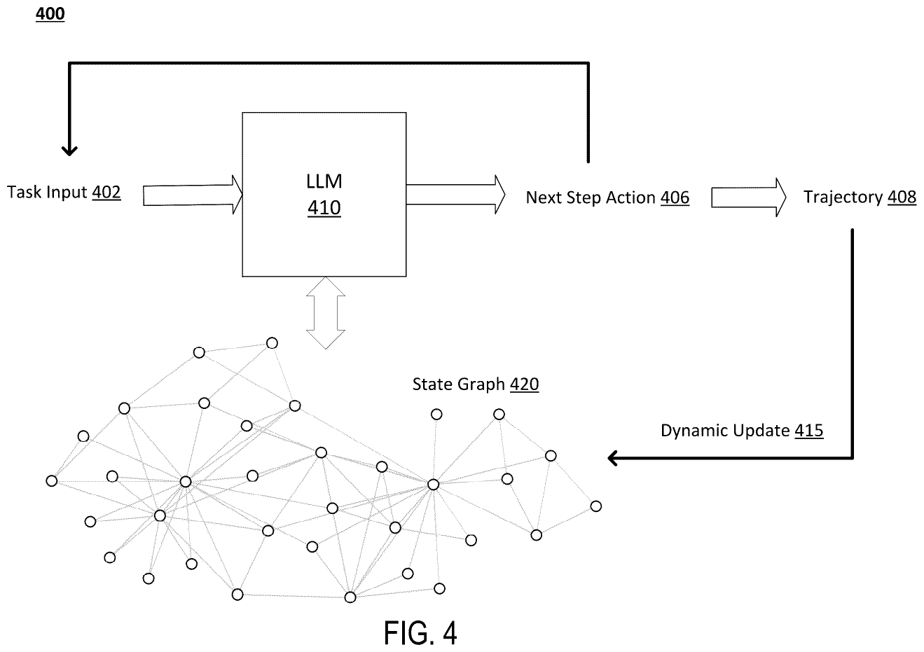

FIG. 4 provides a simplified diagram illustrating an LLM based framework generating a next step action and dynamically update a state graph for guiding action execution, according to some embodiments. The framework 400 comprises one or more LLM 410, a memory storing a stage graph 420, which is operatively connected to LLM 410. Specifically, LLM 410 may receive a task request 402, e.g., from a user, based on which to generate and execute predicted actions at one or more turns. The action execution of LLM 410 may be based on searching the stage graph 420.

In one embodiment, framework 400 may control LLM agent behavior of LLM 410 using state graph 420 as a context for LLM agent execution. In response to a task input 402 (e.g., similar to 105 in FIG. 1), the LLM agent 410 may search through the state graph 420. Each node of state graph 420 represents a distinct state correlating with predefined agent executions, viewed as deterministic actions. For example, each state is treated as a minimal decision point of an agent. This can encompass various scenarios such as an action (search, payment, etc.), a single step of reasoning, or even a status change. Each state is a discrete unit that builds up an agentic flow.

Edges between these nodes define transitions, representing decision-making processes that lead from one state to another. Transitions in the state graph 420 denote the movement from one state to another. These transitions are directed edges in the graph, illustrating the flow of decisions. Each transition is triggered by specific conditions and leads to a new state, thereby defining the agent's behavior over time. For example, there may be two types of transitions in state graph 420: conditional transitions, which require reasoning by the agent, such as the use of an LLM or other specified conditions to decide whether the transition can be made, and unconditional transitions which are automatically passed if the flow goes to this transition. No additional reasoning or conditions need to be met for the agent to move to the next state.

In this way, state graph 420 represents that each state is strategically connected to subsequent potential states, thereby systematizing the agent's execution workflows through controlled state transitions.

In one embodiment, LLM agent 410 may search through stage graph 420 to retrieve relevant information such as a subset of nodes and edges based on the task input 402. The retrieved information may then be concatenated with task input 402 to feed to LLM agent 410, which in turn generates a next step action 406. The generated next step action 406 may in turn be fed back to the input end, such that the next generation may be conditioned on previously executed actions. The sequence of generated actions over a time period may thus form a trajectory 408 for performing the task input 402.

In one embodiment, state graph 420 may be dynamically modified (via the data path 415) using generated trajectories 408, e.g., to add or remove nodes or edges representing unseen tasks. In this way, at each action turn, the LLM agent 410 may generate a next step action 406 based on a dynamically updated state graph 420 and prior action trajectory.

In one embodiment, the transition mechanism between states may be constructed by different implementations, such as heuristic/rules-based transition, classifier-based transition, and direct LLM reasoning transition, and/or the like. For example, for heuristic-based transitions, a set of pre-defined conditional rules such as context matching are employed to facilitate state progression. For another example, classifier-based transitions utilize a neural network to predict the most probable subsequent state from a given current state.

For another example, an LLM (which may be the same or a different LLM than LLM agent 410) may determine the next appropriate states for a particular transition from one state to another, using the intrinsic reasoning capabilities of the LLM. After the next states are determined, the LLM agent may in turn determine and execute the next step action 406 to transit to the next states.

In one embodiment, the state graph 420 may be developed through different implementations. For example, the state graph 420 may be pre-designed and pre-stored by human experts to ensure precise control and alignment with desired agent behaviors. For another example, a data-driven method utilizes extensive datasets of agent executions to train and optimize the state graph 420, e.g., the nodes and edges of state graph 420 may be updated via a backpropagation algorithm using training data of past trajectories.

For another example, an LLM (which may be the same or a different LLM model than LLM agent 410) may be utilized to construct and/or to edit the state graph 420, such as the addition or removal of nodes and edges, e.g., by inputting a text document and a prompt instructing the LLM to output a stage graph structure. In this way, the state graph 420 may be adapted and/or dynamically evolved based on the operational feedback.

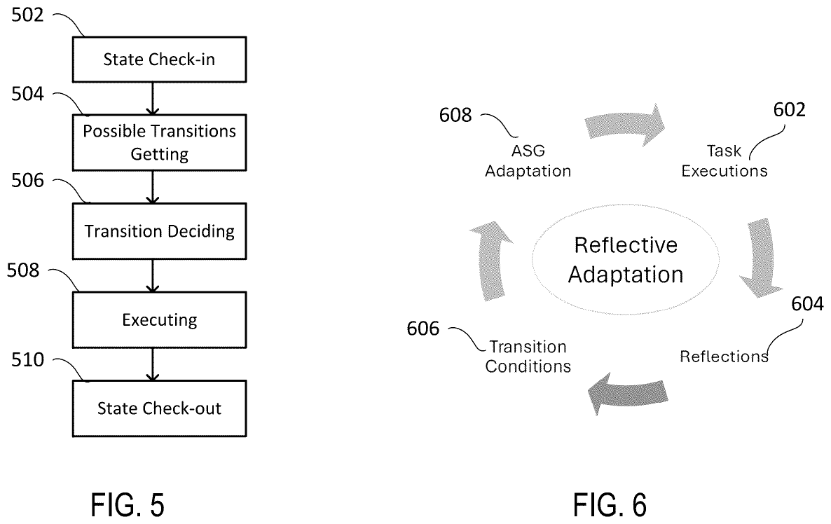

FIG. 5 provides an example diagram illustrating an inference of a controllable agent generation using stage graph 420 in FIG. 4, according to one or more embodiments described herein. In one embodiment, an inference of a controllable agent generation in response to a task is as follows. At step 502, the LLM agent 410 checks which state it is at the beginning of the task. At step 504, the LLM agent 410 gets next possible transitions via edges sprouting from the initial stage in stage graph 420. At step 506, the LLM agent 410 may check all transitions from a source state to a target state and decide the next state to pass. At step 508, the LLM agent 410 may execute state after transition and go to step 504 until reaching a terminal state. At step 510, if LLM agent 410 reaches the terminal state, it checks out and finish the task. By defining specific states and transitions, the behavior of the LLM agent 410 can be controlled and predicted, ensuring that it follows a logical path to complete the task.

FIG. 6 provides an example diagram illustrating reflective adaption of the stage graph 420 in FIG. 4 based on the task executions, according to one or more embodiments. For example, stage graph 420 is updated via reflecting on the task executions. A sample prompt template for an LLM to update the stage graph 420 may take a form similar to:
You have the following possible states:
{state_desc}
{state_transitions}
Given the following execution steps
{state_1}{execution_1}
{state_2}{execution_2}
. . . {state_k}{execution_k}
Can you reflect on your state transition
conditions?

For example, as shown in FIG. 6, the LLM agent may executes task at step 602, reflects on the execution results 604, improves the transition conditions at step 606 (e.g., via the prompt template above) and finally update the stage graph 420 for next round execution at step 608.

### Computer and Network Environment

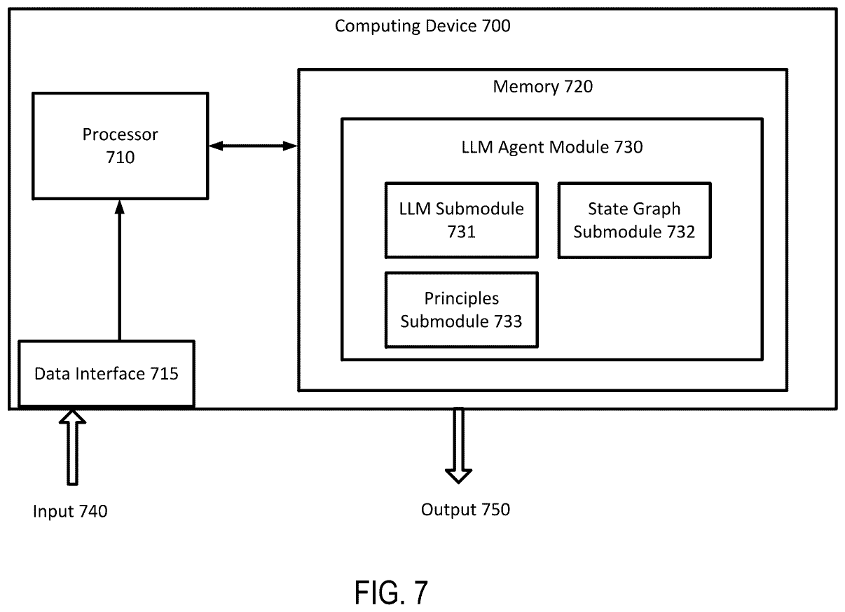

FIG. 7 is a simplified diagram illustrating a computing device implementing the LLM agent framework described in FIGS. 1-6, according to one embodiment described herein. As shown in FIG. 7, computing device 700 includes a processor 710 coupled to memory 720. Operation of computing device 700 is controlled by processor 710. And although computing device 700 is shown with only one processor 710, it is understood that processor 710 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 700. Computing device 700 may be implemented as a stand-alone subsystem, as a board added to a computing device, and/or as a virtual machine.

Memory 720 may be used to store software executed by computing device 700 and/or one or more data structures used during operation of computing device 700. Memory 720 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 710 and/or memory 720 may be arranged in any suitable physical arrangement. In some embodiments, processor 710 and/or memory 720 may be implemented on a same board, in a same package (e.g., system-in-package), on a same chip (e.g., system-on-chip), and/or the like. In some embodiments, processor 710 and/or memory 720 may include distributed, virtualized, and/or containerized computing resources. Consistent with such embodiments, processor 710 and/or memory 720 may be located in one or more data centers and/or cloud computing facilities.

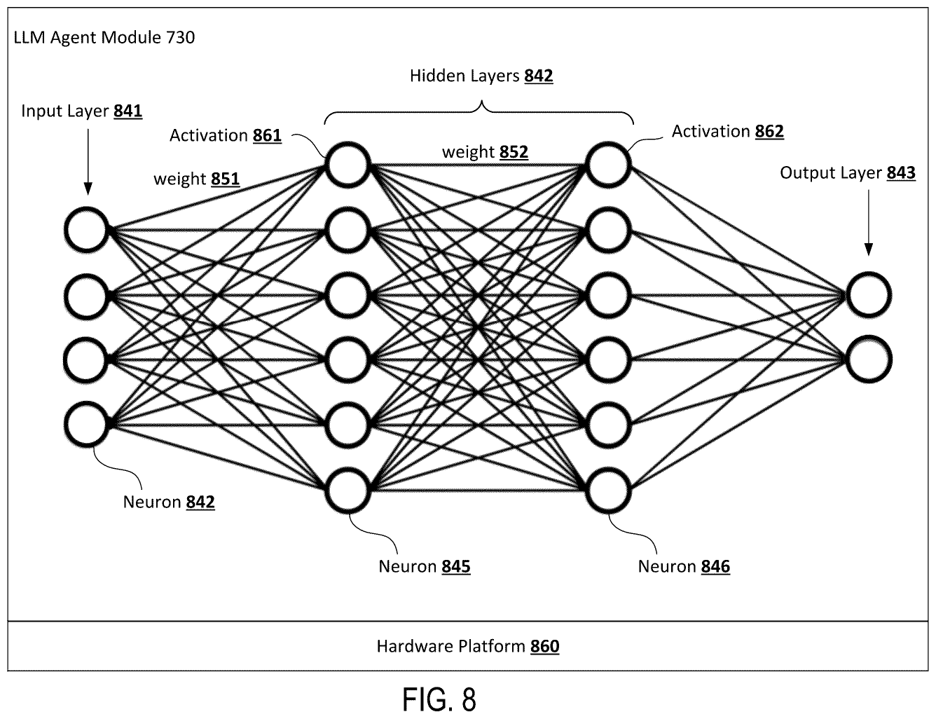

In another embodiment, processor 710 may comprise multiple microprocessors and/or memory 720 may comprise multiple registers and/or other memory elements such that processor 710 and/or memory 720 may be arranged in the form of a hardware-based neural network, as further described in FIG. 8.

In some examples, memory 720 may include non-transitory, tangible, machine readable media that includes executable code that when run by one or more processors (e.g., processor 710) may cause the one or more processors to perform the methods described in further detail herein. For example, as shown, memory 720 includes instructions for LLM agent module 730 that may be used to implement and/or emulate the systems and models, and/or to implement any of the methods described further herein. LLM agent module 730 may receive input 740 such as an input training data (e.g., training tasks) via the data interface 715 and generate an output 750 which may be task output in response to the task request 102.

The data interface 715 may comprise a communication interface, a user interface (such as a voice input interface, a graphical user interface, and/or the like). For example, the computing device 700 may receive the input 740 (such as a training dataset) from a networked database via a communication interface. Or the computing device 700 may receive the input 740, such as task request 102, from a user via the user interface.

In some embodiments, the LLM agent module 730 is configured to generate and execute actions at multiple turns to complete a task. The LLM agent module 730 may further include LLM submodule 731 (e.g., similar to 110 in FIG. 1), and stage graph submodule 732 (e.g., similar to 420 in FIG. 4), and principles submodule 733.

Some examples of computing devices, such as computing device 700 may include non-transitory, tangible, machine readable media that include executable code that when run by one or more processors (e.g., processor 710) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 8 is a simplified diagram illustrating the neural network structure implementing the LLM agent module 730 described in FIG. 8, according to some embodiments. In some embodiments, the LLM agent module 830 and/or one or more of its submodules 831-232 may be implemented at least partially via an artificial neural network structure shown in FIG. 8. The neural network comprises a computing system that is built on a collection of connected units or nodes, referred to as neurons (e.g., 844, 845, 846). Neurons are often connected by edges, and an adjustable weight (e.g., 851, 852) is often associated with the edge. The neurons are often aggregated into layers such that different layers may perform different transformations on the respective input and output transformed input data onto the next layer.

For example, the neural network architecture may comprise an input layer 841, one or more hidden layers 842 and an output layer 843. Each layer may comprise a plurality of neurons, and neurons between layers are interconnected according to a specific topology of the neural network topology. The input layer 841 receives the input data (e.g., 840 in FIG. 8), such as a text prompt describing options of actions, a task request, and/or the like. The number of nodes (neurons) in the input layer 841 may be determined by the dimensionality of the input data (e.g., the length of a vector of a text prompt). Each node in the input layer represents a feature or attribute of the input.

The hidden layers 842 are intermediate layers between the input and output layers of a neural network. It is noted that two hidden layers 842 are shown in FIG. 8B for illustrative purpose only, and any number of hidden layers may be utilized in a neural network structure. Hidden layers 842 may extract and transform the input data through a series of weighted computations and activation functions.

For example, as discussed in FIG. 8, the LLM agent module 830 receives an input 840 of a text prompt and transforms the input into an output 850 of a task execution result. To perform the transformation, each neuron receives input signals, performs a weighted sum of the inputs according to weights assigned to each connection (e.g., 851, 852), and then applies an activation function (e.g., 861, 862, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 841 is transformed into rather different values indicative data characteristics corresponding to a task that the neural network structure has been designed to perform.

The output layer 843 is the final layer of the neural network structure. It produces the network's output or prediction based on the computations performed in the preceding layers (e.g., 841, 842). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the LLM agent module 730 and/or one or more of its submodules 731-733 may comprise the transformative neural network structure of layers of neurons, and weights and activation functions describing the non-linear transformation at each neuron. Such a neural network structure is often implemented on one or more hardware processors 810, such as a graphics processing unit (GPU). An example neural network may be a Transformer based language model, and/or the like.

In one embodiment, the LLM agent module 730 and its submodules 731-733 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

In one embodiment, the LLM agent module 730 and its submodules 731-733 may be implemented by hardware, software and/or a combination thereof. For example, layers 841, 842, 843 and/or neurons 842, 845, 846, and operations there between such as activations 861, 862, and/or the like, of the LLM agent module 730 and its submodules 731-733 may be realized via a plurality of processor-readable code implemented on various hardware platforms 860, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 860 used to implement the neural network structure is specifically configured based on factors such as the complexity of the neural network, the scale of the tasks (e.g., training time, input data scale, size of training dataset, etc.), and the desired performance.

In another embodiment, some or all of layers 841, 842, 843 and/or neurons 842, 845, 846, and operations there between such as activations 861, 862, and/or the like, of the LLM agent module 730 and its submodules 731-733 may be realized via one or more ASICs. For example, each neuron 842, 845 and 846 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the LLM agent module 730 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based LLM agent module 730 and one or more of its submodules 731-733 may be trained by iteratively updating the underlying parameters (e.g., weights 851, 852, etc., bias parameters and/or coefficients in the activation functions 861, 862 associated with neurons) of the neural network based on the loss. For example, during forward propagation, the training data such as training task inputs are fed into the neural network. The data flows through the network's layers 841, 842, with each layer performing computations based on its weights, biases, and activation functions until the output layer 843 produces the network's output 850. In some embodiments, output layer 843 produces an intermediate output on which the network's output 850 is based.

The output generated by the output layer 843 is compared to the expected output (e.g., a “ground-truth” annotated in training data) from the training data, to compute a loss function that measures the discrepancy between the predicted output and the expected output. For example, the loss function may be cross entropy, MMSE, and/or the like. Given the loss, the negative gradient of the loss function is computed with respect to each weight of each layer individually. Such negative gradient is computed one layer at a time, iteratively backward from the last layer 843 to the input layer 841 of the neural network. These gradients quantify the sensitivity of the network's output to changes in the parameters. The chain rule of calculus is applied to efficiently calculate these gradients by propagating the gradients backward from the output layer 843 to the input layer 841.

In one embodiment, the neural network based LLM agent module 730 and one or more of its submodules 731-733 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning-in other words, backward propagation and forward propagation may occur for both “training” and “inference” stages of the neural network mode.

In one embodiment, LLM agent module 730 and its submodules 731-733 may be housed at a centralized server (e.g., computing device 800) or one or more distributed servers. For example, one or more of LLM agent module 730 and its submodules 731-733 may be housed at an external servers. The different modules may be communicatively coupled by building one or more connections through application programming interfaces (APIs) for each respective module. Additional network environment for the distributed servers hosting different modules and/or submodules may be discussed in FIG. 4.

During a backward pass, parameters of the neural network are updated backwardly from the last layer to the input layer (backpropagating) based on the computed negative gradient using an optimization algorithm to minimize the loss. The backpropagation from the last layer 843 to the input layer 841 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as processing a new task.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in artificial and/or virtual agent operations.

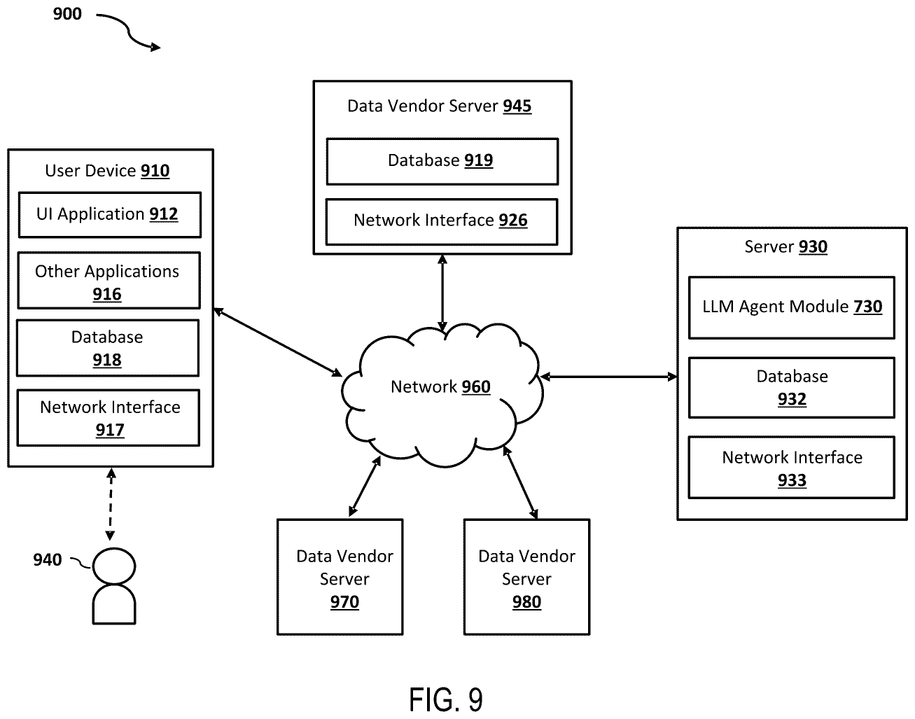

FIG. 9 is a simplified block diagram of a networked system 900 suitable for implementing the LLM agent framework described in FIG. 1 and other embodiments described herein. In one embodiment, system 900 includes the user device 910 which may be operated by user 940, data vendor servers 945, 970 and 980, server 930, and other forms of devices, servers, and/or software components that operate to perform various methodologies in accordance with the described embodiments. Exemplary devices and servers may include device, stand-alone, and enterprise-class servers which may be similar to the computing device 700 described in FIG. 7, operating an OS such as a MICROSOFT® OS, a UNIX® OS, a LINUX® OS, or other suitable device and/or server-based OS. It can be appreciated that the devices and/or servers illustrated in FIG. 9 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 910, data vendor servers 945, 970 and 980, and the server 930 may communicate with each other over a network 960. User device 910 may be utilized by a user 940 (e.g., a driver, a system admin, etc.) to access the various features available for user device 910, which may include processes and/or applications associated with the server 930 to receive an output data anomaly report.

User device 910, data vendor server 945, and the server 930 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 900, and/or accessible over network 960.

User device 910 may be implemented as a communication device that may utilize appropriate hardware and software configured for wired and/or wireless communication with data vendor server 945 and/or the server 930. For example, in one embodiment, user device 910 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 910 of FIG. 9 contains a user interface (UI) application 912, and/or other applications 916, which may correspond to executable processes, procedures, and/or applications with associated hardware. For example, the user device 910 may receive a message indicating a task output from the server 930 and display the message via the UI application 912. In other embodiments, user device 910 may include additional or different modules having specialized hardware and/or software as required.

In one embodiment, UI application 912 may communicatively and interactively generate a UI for an AI agent implemented through the LLM agent module 230 (e.g., an LLM agent) at server 930. In at least one embodiment, a user operating user device 910 may enter a user utterance, e.g., via text or audio input, such as a question, uploading a document, and/or the like via the UI application 912. Such user utterance may be sent to server 930, at which LLM agent module 730 may generate a response via the process described in FIG. 1. The LLM agent module 730 may thus cause a display of task output at UI application 912 and interactively update the display in real time with the user utterance.

In various embodiments, user device 910 includes other applications 916 as may be desired in particular embodiments to provide features to user device 910. For example, other applications 916 may include security applications for implementing client-side security features, programmatic client applications for interfacing with appropriate application programming interfaces (APIs) over network 960, or other types of applications. Other applications 916 may also include communication applications, such as email, texting, voice, social networking, and IM applications that allow a user to send and receive emails, calls, texts, and other notifications through network 960. For example, the other application 916 may be an email or instant messaging application that receives a prediction result message from the server 930. Other applications 916 may include device interfaces and other display modules that may receive input and/or output information. For example, other applications 916 may contain software programs for asset management, executable by a processor, including a graphical user interface (GUI) configured to provide an interface to the user 940 to view the task output.

User device 910 may further include database 918 stored in a transitory and/or non-transitory memory of user device 910, which may store various applications and data and be utilized during execution of various modules of user device 910. Database 918 may store user profile relating to the user 940, predictions previously viewed or saved by the user 940, historical data received from the server 930, and/or the like. In some embodiments, database 918 may be local to user device 910. However, in other embodiments, database 918 may be external to user device 910 and accessible by user device 910, including cloud storage systems and/or databases that are accessible over network 960.

User device 910 includes at least one network interface component 917 adapted to communicate with data vendor server 945 and/or the server 930. In various embodiments, network interface component 917 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 945 may correspond to a server that hosts database 919 to provide training datasets including training tasks to the server 930. The database 919 may be implemented by one or more relational database, distributed databases, cloud databases, and/or the like.

The data vendor server 945 includes at least one network interface component 926 adapted to communicate with user device 910 and/or the server 930. In various embodiments, network interface component 926 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 945 may send asset information from the database 919, via the network interface 926, to the server 930.

The server 930 may be housed with the LLM agent module 730 and its submodules described in FIG. 7. In some implementations, LLM agent module 730 may receive data from database 919 at the data vendor server 945 via the network 960 to generate a task output. The generated task output may also be sent to the user device 910 for review by the user 940 via the network 960.

The database 932 may be stored in a transitory and/or non-transitory memory of the server 930. In one implementation, the database 932 may store data obtained from the data vendor server 945. In one implementation, the database 932 may store parameters of the LLM agent module 730. In one implementation, the database 932 may store previously generated task output, and the corresponding input feature vectors.

In some embodiments, database 932 may be local to the server 930. However, in other embodiments, database 932 may be external to the server 930 and accessible by the server 930, including cloud storage systems and/or databases that are accessible over network 960.

The server 930 includes at least one network interface component 933 adapted to communicate with user device 910 and/or data vendor servers 945, 970 or 980 over network 960. In various embodiments, network interface component 933 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 960 may be implemented as a single network or a combination of multiple networks. For example, in various embodiments, network 960 may include the Internet or one or more intranets, landline networks, wireless networks, and/or other appropriate types of networks. Thus, network 960 may correspond to small scale communication networks, such as a private or local area network, or a larger scale network, such as a wide area network or the Internet, accessible by the various components of system 900.

### Example Work Flow

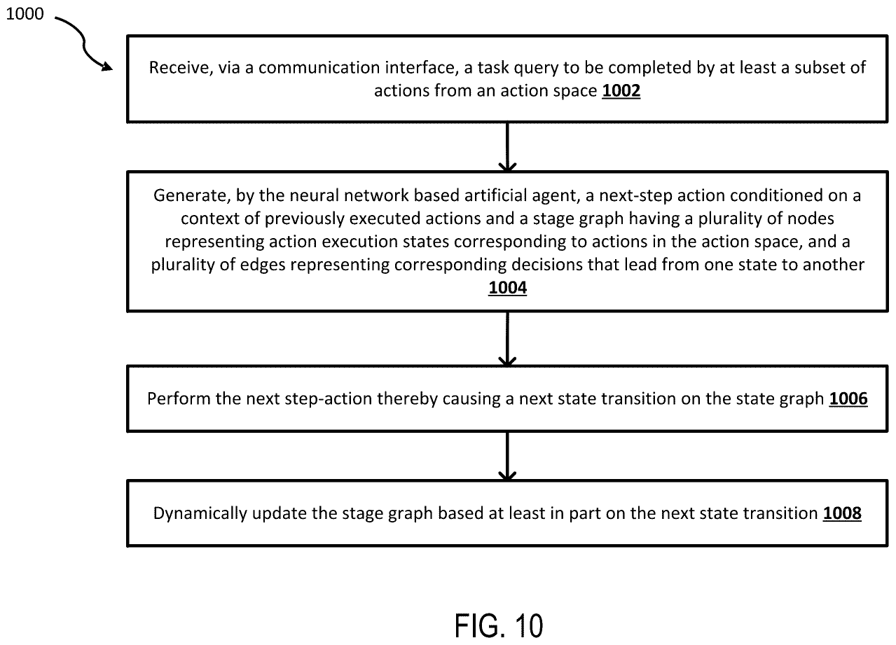

FIG. 10 is an example logic flow diagram illustrating an example method of controlling a neural network based artificial intelligence (AI) agent, according to embodiments described herein. One or more of the processes of method 1000 may be implemented, at least in part, in the form of executable code stored on non-transitory, tangible, machine-readable media that when run by one or more processors may cause the one or more processors to perform one or more of the processes. In some embodiments, method 600 corresponds to the operation of the neural network parallel adaptation module 330 (e.g., FIGS. 3 and 5).

As illustrated, the method 600 includes a number of enumerated steps, but aspects of the method 600 may include additional steps before, after, and in between the enumerated steps. In some aspects, one or more of the enumerated steps may be omitted or performed in a different order.

At step 1002, a task query (e.g., 105 in FIG. 1) to be completed by at least a subset of actions from an action space may be received via a communication interface (e.g., data interface 715 in FIG. 7, network interface 933 in FIG. 9).

At step 1004, the neural network based AI agent (e.g., LLM agent 410 in FIG. 4) may generate a next-step action conditioned on a context of previously executed actions and a stage graph (e.g., 420 in FIG. 4) having a plurality of nodes representing action execution states corresponding to actions in the action space, and a plurality of edges representing corresponding decisions that lead from one state to another. For example, the plurality of edges may be determined based on a dataset of prior trajectories of user-agent interactions and a pre-defined set of rules and each rule species a respective state-transition condition under which a first state leads to a second state, and wherein the first state and the second state represent different actions from the action space determined from the dataset of prior trajectories. For another example, the plurality of edges may be determined using a neural network based classifier model that is trained based on a dataset of prior trajectories of user-agent interactions to predict a probable subsequent state given a current state. For another example,

At step 1006, the next step-action may be executed at an environment thereby causing a next state transition on the state graph.

At step 1008, the stage graph 420 may be dynamically updated based at least in part on the next state transition, as described in relation to 415 in FIG. 4. For example, the stage graph may be dynamically updated using a neural network based language model, e.g., by performing an addition or removal of one or more nodes or edges from the state graph.

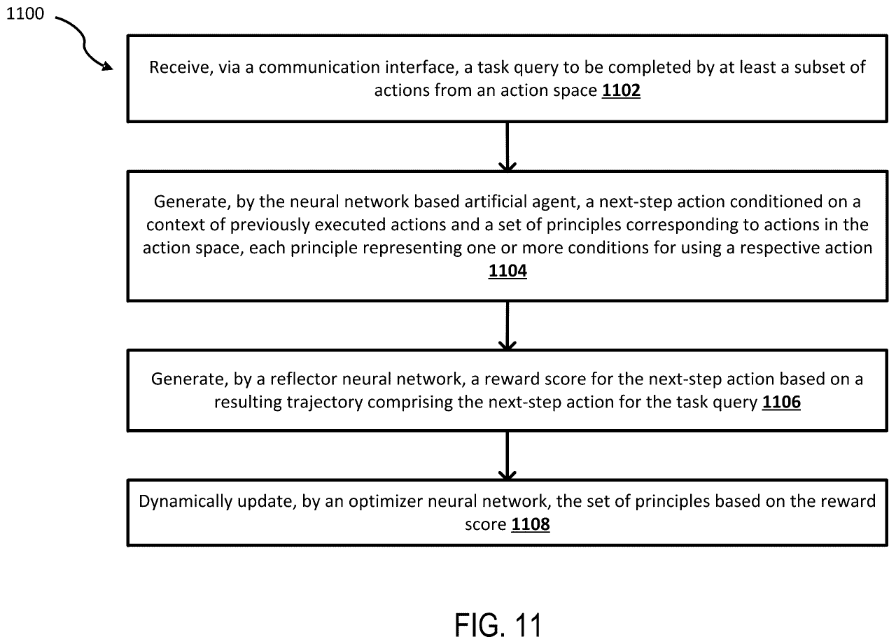

FIG. 11 is an example logic flow diagram illustrating an example method of controlling a neural network based artificial intelligence (AI) agent, according to embodiments described herein. One or more of the processes of method 1100 may be implemented, at least in part, in the form of executable code stored on non-transitory, tangible, machine-readable media that when run by one or more processors may cause the one or more processors to perform one or more of the processes. In some embodiments, method 600 corresponds to the operation of the neural network parallel adaptation module 330 (e.g., FIGS. 3 and 5).

As illustrated, the method 600 includes a number of enumerated steps, but aspects of the method 600 may include additional steps before, after, and in between the enumerated steps. In some aspects, one or more of the enumerated steps may be omitted or performed in a different order.

At step 1102, a task query (e.g., 105 in FIG. 1) to be completed by at least a subset of actions from an action space may be received via a communication interface (e.g., data interface 715 in FIG. 7, network interface 933 in FIG. 9).

At step 1104, the neural network based AI agent (e.g., 310 in FIG. 3) may generate a next-step action conditioned on a context of previously executed actions and a set of principles corresponding to actions in the action space, each principle representing one or more conditions for using a respective action. For example, the set of principles are tunable instructions on a usage of each action.

In one implementation, an input combining the context of previously executed actions, observations from an environment on which the previously executed actions are executed, and the set of principles in a pre-defined prompt format is fed to the neural network based artificial agent.

At step 1106, a reflector neural network (e.g., 320 in FIG. 3) may generate a reward score for the next-step action based on a resulting trajectory comprising the next-step action for the task query. For example, an input combining the resulting trajectory, the reward feedback from the environment observations from an environment on which the previously executed actions are executed, and the set of principles in a pre-defined prompt format is fed to the reflector neural network. For another example, the reward score is generated further based on a reward feedback from an environment at which the next-step action is executed.

At step 1108, an optimizer neural network (e.g., 330 in FIG. 3) may dynamically update the set of principles based on the reward score. For example, the optimizer neural network may generate an updated set of principles based on an input combining the set of principles and the reward score in a pre-defined prompt format. The updated set of principles are individually generated for each trajectory, and then summarized into a new set of principles across a set of trajectories corresponding to a set of task queries. Alternatively, the updated set of principles are generated based on the input concatenating a set of reward scores corresponding to a set of trajectories corresponding to a set of task queries.

In steps 1104-1108, the neural network based artificial agent, the reflector neural network, and the optimizer neural network may be a same or different neural network language model.

In one embodiment, methods 1000 and 1100 are applicable in a variety of applications. For example, the task request (e.g., 105 in FIG. 1) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing methods 1000 and/or 1100, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing methods 1000 and 1100 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Example Data Performance

In one embodiment, data experiments are conducted for the reflective optimization LLM agents described in FIGS. 1-11. Example baselines include existing Act, ReAct (Yao et al., ReAct: Synergizing reasoning and acting in language models, in proceedings of International Conference on Learning Representations (ICLR), 2023), Reflexion (Shinn et al., Reflexion: Language agents with verbal reinforcement learning. arXiv preprint arXiv: 2303.11366, 2023) agent reasoning methods. GPT-3.5-Turbo-0125 and GPT-4-Turbo-2024-04-09 as two foundation LLMs. Here, the executor, reflector and optimizer are set to be the same language model.

The LLM agent is evaluated on three tool environments and one WebShop environment. Tool environments support the designing of WEATHER, MOVIE, and ACADEMIA agents. Tasks are 60 queries and actions are a set of function calls. Webshop environment is a web browser simulation. Agent performs either search and click actions to complete 251 online shopping tasks. Agent also generates the searching query and clicking button for search and click actions, respectively. The reward is reported as the evaluation metric.

For optimizing the WebShop agent, a reward-based reflector is adopted. The query tasks are randomly split into training, validation, and test tasks with a ratio of 3:1:1. During each training step, a batch of training tasks are sampled to execute and use RPO to optimize the principles. Performance on validation tasks is used for early stopping, and results are reported on test tasks. For tool agents, a self-reflector is used without rewards, making reflection tasks the same as test tasks. The training batch size are adopted in [10,20,40] for WebShop and [2,4,6] for tool environments.

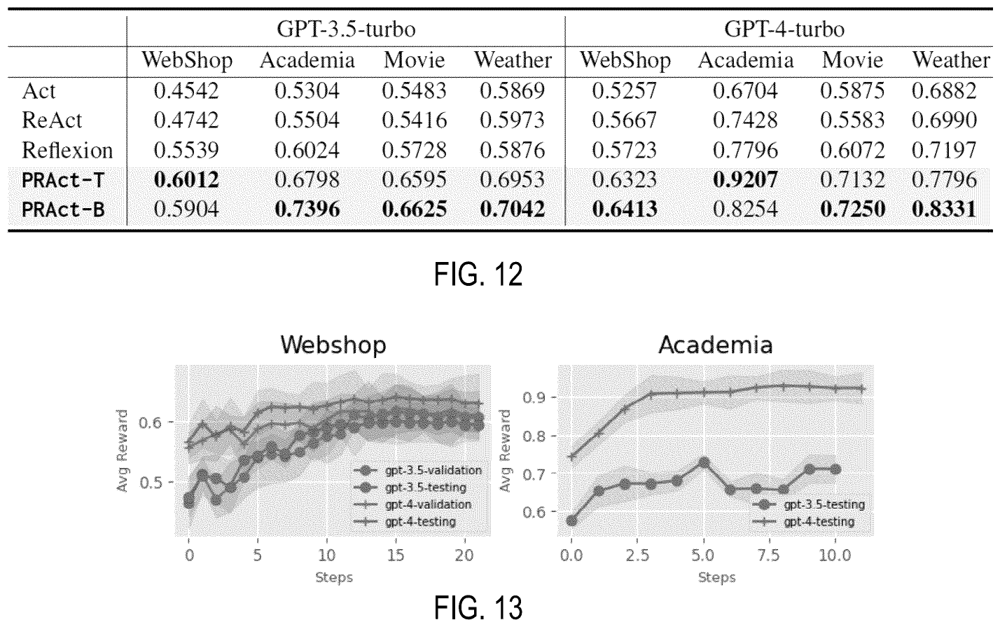

FIG. 12 shows an overall performance comparing methods 1000 and 1100 against the agent baselines. PRAct-T and PRAct-B represent methods 1000 and 1100 methods with RPO-Traj and RPO-Batch optimization methods, respectively. It is observed consistently better performance of PRAct agent, which demonstrates the effectiveness of principles in improving agent performance. Between the two optimization methods, i.e. PRAct-T and PRAct-B, PRAct-B generally performs better than PRAct-T. The reason is that summarizing principles from a batch of reflections enables potential reasoning across trajectories. However, PRAct-T outperforms PRAct-B due to the potential weaker long context understanding ability of GPT-3.5-Turbo, which indicates batch-wise optimization is more suitable for larger models.

FIG. 13 shows an optimization curve. Although at each step, the best principle may not always be picked out of the sampled action principles on the validation set, consistent improvement is achieved over time. Notably, with action principles optimized by PRAct, LLM agents under GPT-3.5-Turbo can match the performance of GPT-4-turbo in Webshop environment.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of controlling a neural network based artificial intelligent (AI) agent, comprising:
receiving, via a communication interface, a task query to be completed by at least a subset of actions from an action space;
generating, by the neural network based AI agent, a next-step action conditioned on a context of previously executed actions and a set of principles corresponding to actions in the action space, each principle representing one or more conditions for using a respective action;
generating, by a reflector neural network, a reward score for the next-step action based on a resulting trajectory comprising the next-step action for the task query; and
dynamically updating, by an optimizer neural network, the set of principles based on the reward score.

2. The method of claim 1, wherein the set of principles are tunable instructions on a usage of each action.

3. The method of claim 1, further comprising:
generating an input combining the context of previously executed actions, observations from an environment on which the previously executed actions are executed, and the set of principles in a pre-defined prompt format to the neural network based artificial agent.

4. The method of claim 1, wherein the reward score is generated further based on a reward feedback from an environment at which the next-step action is executed.

5. The method of claim 4, further comprising:
generating an input combining the resulting trajectory, the reward feedback from the environment observations from an environment on which the previously executed actions are executed, and the set of principles in a pre-defined prompt format to the reflector neural network.

6. The method of claim 1, wherein the dynamically updating, by the optimizer neural network, the set of principles comprises:
generating, by the optimizer neural network, an updated set of principles based on an input combining the set of principles and the reward score in a pre-defined prompt format.

7. The method of claim 6, wherein the updated set of principles are individually generated for each trajectory, and then summarized into a new set of principles across a set of trajectories corresponding to a set of task queries.

8. The method of claim 6, wherein the updated set of principles are generated based on the input concatenating a set of reward scores corresponding to a set of trajectories corresponding to a set of task queries.

9. The method of claim 1, wherein the neural network based artificial agent, the reflector neural network, and the optimizer neural network are a same or different neural network language model.

10. The method of claim 1, wherein the generating, by the neural network based AI agent, the next-step action comprises:
generating, by at least one Application-Specific Integrated Circuit (ASIC) performing a multiplicative and/or accumulative operation for a neural network language model, a next token based at least in prat on previously generated tokens; and
generating a natural language output representing the next-step action combining a sequence of generated tokens.

11. The method of claim 1, wherein the task query includes a query to identify an information technology (IT) anomaly relating to a usage of an IT component, and the method further comprises:
receiving an observation from an environment at which the next-step action is executed;
determining that the observation representing an information technology anomaly; and
causing an alert relating to the information technology anomaly to be displayed at a visualized user interface.

12. A system of controlling a neural network based artificial intelligent (AI) agent, the system comprising:
a communication interface receiving a task query to be completed by at least a subset of actions from an action space;
a memory storing a plurality of processor-readable instructions; and
one or more hardware processing circuits to execute the plurality of processor-readable instructions to perform operations comprising:
generating, by the neural network based AI agent, a next-step action conditioned on a context of previously executed actions and a set of principles corresponding to actions in the action space, each principle representing one or more conditions for using a respective action;
generating, by a reflector neural network, a reward score for the next-step action based on a resulting trajectory comprising the next-step action for the task query; and
dynamically updating, by an optimizer neural network, the set of principles based on the reward score.

13. The system of claim 12, wherein the set of principles are tunable instructions on a usage of each action.

14. The system of claim 12, wherein the operations further comprise:
generating an input combining the context of previously executed actions, observations from an environment on which the previously executed actions are executed, and the set of principles in a pre-defined prompt format to the neural network based artificial agent.

15. The system of claim 12, wherein the reward score is generated further based on a reward feedback from an environment at which the next-step action is executed.

16. The system of claim 15, wherein the operations further comprise:
generating an input combining the resulting trajectory, the reward feedback from the environment observations from an environment on which the previously executed actions are executed, and the set of principles in a pre-defined prompt format to the reflector neural network.

17. The system of claim 12, wherein the operation of dynamically updating, by the optimizer neural network, the set of principles comprises:
generating, by the optimizer neural network, an updated set of principles based on an input combining the set of principles and the reward score in a pre-defined prompt format.

18. The system of claim 17, wherein the updated set of principles are individually generated for each trajectory, and then summarized into a new set of principles across a set of trajectories corresponding to a set of task queries.

19. The system of claim 18, wherein the updated set of principles are generated based on the input concatenating a set of reward scores corresponding to a set of trajectories corresponding to a set of task queries.

20. A non-transitory processor-readable medium storing a plurality of instructions for controlling a neural network based artificial intelligence (AI) agent, the plurality of instructions being executed by one or more hardware processing circuits to perform operations comprising:
receiving, via a communication interface, a task query to be completed by at least a subset of actions from an action space;
generating, by the neural network based AI agent, a next-step action conditioned on a context of previously executed actions and a set of principles corresponding to actions in the action space, each principle representing one or more conditions for using a respective action;
generating, by a reflector neural network, a reward score for the next-step action based on a resulting trajectory comprising the next-step action for the task query; and
dynamically updating, by an optimizer neural network, the set of principles based on the reward score.
